(19) United States
(12) Patent Application Publication
(10) Pub. No.: US 2026/0098972 A1
(43) Pub. Date: Apr. 9, 2026

(54) ENHANCED GNSS RESIDUAL DETERMINATION

(71) Applicant: QUALCOMM Incorporated, San Diego, CA (US)

(72) Inventors: Yuxiang PENG, San Jose, CA (US); Ning LUO, Cupertino, CA (US)

(21) Appl. No.: 18/909,230

(22) Filed: Oct. 8, 2024

(51) Int. Cl. G01S 19/44; G01S 19/07

(52) U.S. Cl. CPC G01S 19/44; G01S 19/071

(57) ABSTRACT

Techniques are disclosed for global navigation satellite system (GNSS) positioning of a GNSS device. Techniques may comprise determining an integer double difference (DD) carrier phase (CP) ambiguity based at least in part on an initial set of DD residuals, the initial set of DD CP residuals based at least in part on (i) one or more CP measurements of one or more GNSS signals, and (ii) an initial trajectory of the GNSS device. Techniques also may comprise determining an updated trajectory of the GNSS device based at least in part on the integer DD CP ambiguity, and determining an updated set of DD CP residuals based at least in part on the updated trajectory of the GNSS device. Techniques further may comprise outputting a position of the GNSS device based at least in part on the updated set of DD CP residuals.

### BACKGROUND

### 1. Field of Disclosure

The present disclosure relates generally to the field of mobile device positioning using radio frequency (RF) signals and, more specifically, to global navigation satellite system (GNSS)-based positioning.

### 2. Description of Related Art

The global navigation satellite system (GNSS) is widely used for positioning consumer electronic devices such as smartphones, as well as for positioning vehicles such as cars, trucks, ships, and aircraft. High-accuracy positioning can provide significant value to various modern-day positioning-based applications. For example, an autonomous driving application may benefit from meter-level positioning information that enables it to determine which particular lane of a road an autonomously driven vehicle is in and may further benefit from sub-meter-level positioning information that enables it to determine where that vehicle is located within the lane.

GNSS-based positioning utilizes residuals, which represents a difference between measured pseudoranges before and after error correction is applied. The residual magnitude is highly correlated to the measurement quality and final positioning solution accuracy. Because of this and other uses of residuals, the accuracy of residuals themselves can be highly important in GNSS-based positioning.

### BRIEF SUMMARY

Techniques described herein are generally directed toward determining more accurate global navigation satellite system (GNSS) residuals than traditional techniques provide. An example method of positioning a GNSS device, according to this disclosure, comprises determining an integer double difference (DD) carrier phase (CP) ambiguity based at least in part on an initial set of one or more DD residuals, wherein the initial set of one or more DD CP residuals are based at least in part on: one or more CP measurements, performed by the GNSS device, of one or more GNSS signals, and an initial trajectory of the GNSS device. The method further comprises determining an updated trajectory of the GNSS device based at least in part on the integer DD CP ambiguity, and determining an updated set of one or more DD CP residuals based at least in part on the updated trajectory of the GNSS device. The method also comprises outputting a position of the GNSS device based at least in part on the updated set of one or more DD CP residuals.

An example global navigation satellite system (GNSS) device, according to this disclosure, comprises one or more GNSS receivers, one or more memories, and one or more processors communicatively coupled with the one or more GNSS receivers and one or more memories. The one or more processors may be configured to determine an integer double difference (DD) carrier phase (CP) ambiguity based at least in part on an initial set of one or more DD residuals, wherein the initial set of one or more DD CP residuals are based at least in part on: one or more CP measurements, performed by the GNSS device using the one or more GNSS receivers, of one or more GNSS signals, and an initial trajectory of the GNSS device. The one or more processors further may be configured to determine an updated trajectory of the GNSS device based at least in part on the integer DD CP ambiguity, and determine an updated set of one or more DD CP residuals based at least in part on the updated trajectory of the GNSS device. The one or more processors also may be configured to and output a position of the GNSS device based at least in part on the updated set of one or more DD CP residuals.

An example apparatus, according to this disclosure, comprises means for determining an integer double difference (DD) carrier phase (CP) ambiguity based at least in part on an initial set of one or more DD residuals, wherein the initial set of one or more DD CP residuals are based at least in part on: one or more CP measurements, performed by a global navigation satellite system (GNSS) device, of one or more GNSS signals, and an initial trajectory of the GNSS device. The apparatus further may comprise means for determining an updated trajectory of the GNSS device based at least in part on the integer DD CP ambiguity, and means for determining an updated set of one or more DD CP residuals based at least in part on the updated trajectory of the GNSS device. The apparatus further may comprise means for outputting a position of the GNSS device based at least in part on the updated set of one or more DD CP residuals.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system that can be used to determine the position of a mobile device (e.g., a global navigation satellite system (GNSS) device), according to an embodiment.

FIG. 2 is a simplified diagram of a GNSS system, according to an embodiment.

FIG. 3 is a flow diagram of a process utilized by embodiments herein that can be used to improve residual quality.

FIG. 4 is a flow diagram of a process by which integer double difference (DD) carrier phase (CP) ambiguity based on a “less reliable” trajectory may be performed, according to some embodiments.

FIG. 5 is a flow diagram of a process by which integer DD CP ambiguity may be based on a “more reliable” trajectory may be performed, according to some embodiments.

FIG. 6 is an illustration of two graphs showing the improvement of DD CP residuals using the embodiments herein on a sample set of data that uses the GPS L5 band.

FIG. 7 is another illustration of two graphs showing the improvement of DD CPs residual using the embodiments herein on a sample set of data that uses the BDS BIC band.

FIG. 8 is a flow diagram of a method of GNSS positioning of a GNSS device, according to an embodiment.

FIG. 9 is a block diagram of an embodiment of a GNSS device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples in which one or more aspects of the disclosure may be implemented are described below, other examples may be used, and various modifications may be made without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification do not necessarily refer to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. Further, a “GNSS device” as used herein, may refer to an electronic device (e.g., mobile device or UE as described above) with circuitry and/or components capable of performing GNSS measurements and determining a GNSS position. As referred to herein, a “GNSS receiver” may refer to such circuitry and/or components or may generically refer to a GNSS device. According to some embodiments, a GNSS device comprising a mobile device and/or UE may be capable of sending and/or receiving data over a wireless communications network. Such a device may be stationary (e.g., permanently or temporarily) or mobile, and may communicate with a Radio Access Network (RAN). Generally put, communication by devices herein may be performed via a cellular network (e.g., via a core network via a RAN, and through the core network). The cellular network may be connected with external networks (such as the Internet) and with other devices. Other mechanisms of connecting to the Internet and/or other data networks are also possible for the devices described herein, such as over wireless local area network (WLAN) networks (e.g., based on the Institute of Electrical and Electronics Engineers (IEEE) 802.11 standard, etc.), and/or the like.

A “space vehicle” (SV) as referred to herein, relates to an object that is capable of transmitting signals to receivers (e.g., GNSS receivers/GNSS devices) on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

Additionally, as used herein, the term “trajectory” refers to a GNSS receiver trajectory (e.g., rover trajectory) unless otherwise specified. As a person of ordinary skill in the art will appreciate, GNSS positioning residual determination may use a GNSS receiver trajectory (e.g., a path the receiver is following on the Earth's surface) and may also use a satellite trajectory (e.g., a path the satellite follows in orbit around the earth, which may be determined using satellite ephemeris data). It can be further noted that a GNSS receiver may be stationary, which may be accounted for in the receiver trajectory.

As previously noted, a GNSS device may determine its GNSS-based positioning by using residuals. The residual magnitude is highly correlated to the measurement quality and accuracy of the final positioning solution. Some GNSS devices may output residuals as measurement parameters for end users to understand how much uncertainty still exists in each measurement. Further, accurate post-carrier-phase (CP) residual analysis can play a critical role in a GNSS machine-learning (ML) process; the ML feature data quality can be highly sensitive to the residual determination accuracy and robustness. Existing double-difference (DD) residual computation mostly relies on the accuracy of real-time position estimation or ground truth (GT). For GNSS devices with slow positioning cadence (e.g., Internet of Things (IoT) smartphones, etc.) a lack of user/UE dynamics can cause large residuals. Moreover, challenging environments (e.g., urban canyons) can result in no GT or inaccurate GT scenarios.

Embodiments address these and other issues by providing techniques to improve the quality of residuals, especially DD CP residuals for precise positioning applications. Generally put, these techniques use a three-iteration process to enhance positioning solution/GP quality. The first iteration involves computing an integer DD CP ambiguity based on a less reliable (e.g., traditional) receiver trajectory, which may be an estimated GNSS receiver position or provided GT trajectory. The second iteration involves generating a more reliable trajectory by using integer DD CP ambiguity. The third generation involves generating residuals (e.g., pseudorange (PR), CP, and Doppler) using the more reliable trajectory. Details regarding this iterative process are provided in the embodiments described herein.

Particular aspects of the subject matter described in this disclosure can be implemented to realize one or more of the following potential advantages. In some examples, by generating and using a more reliable trajectory, the described techniques can provide for more accurate residuals (in particular DD CP residuals) that can be used for GNSS positioning, ML training of GNSS positioning models, and the like. These and other advantages will be apparent to a person of ordinary skill in the art in view of the embodiments described below.

Various embodiments are provided in detail hereafter, following a review of applicable technology.

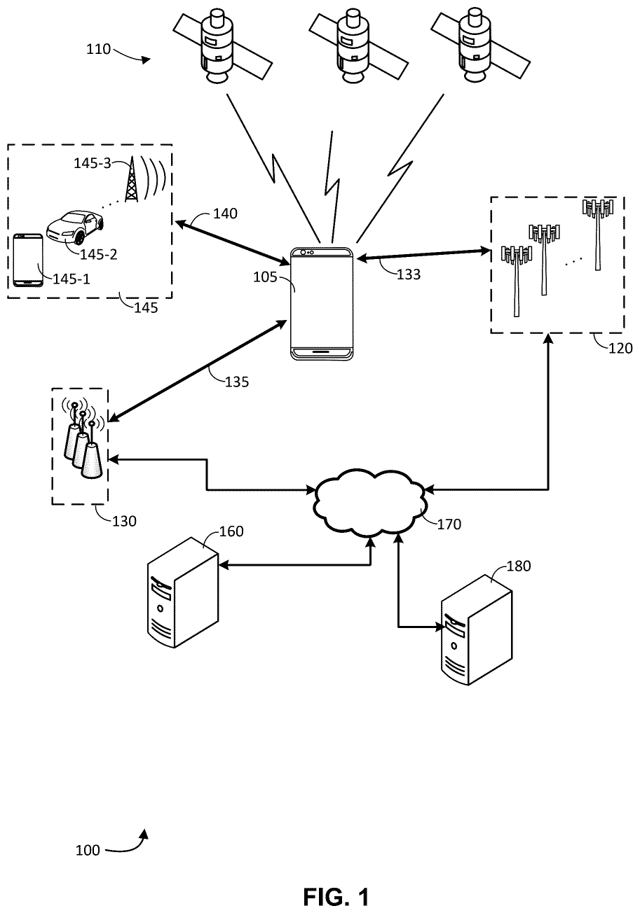

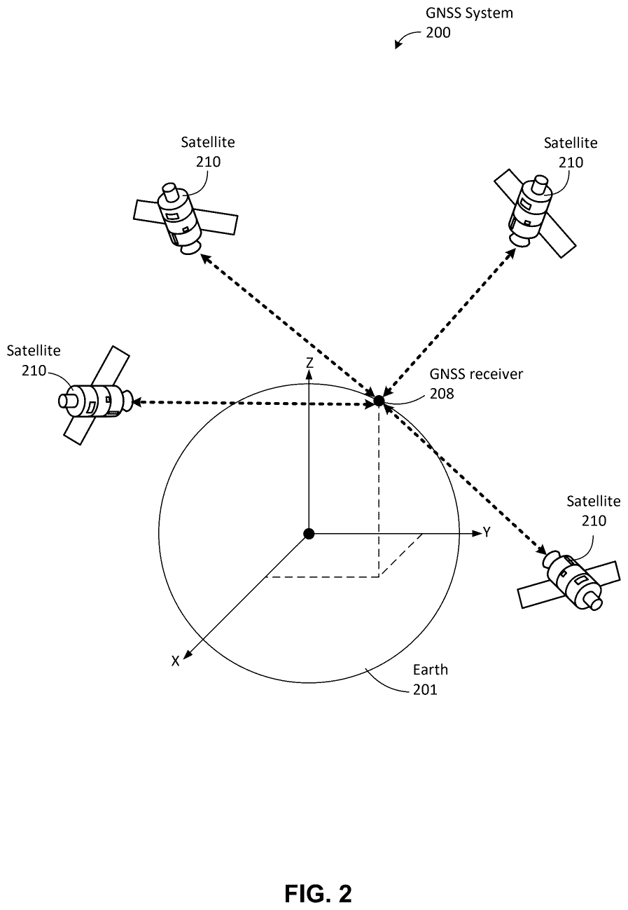

FIG. 1 is a simplified illustration of a positioning system 100 in which a mobile device 105, location server 160, and/or other components of the positioning system 100 can use the techniques provided herein for determining and using enhanced GNSS residuals, according to an embodiment. The techniques described herein may be implemented by one or more components of the positioning system 100. The positioning system 100 can include a mobile device 105; one or more satellites 110 (also referred to as space vehicles (SVs)) for a GNSS such as the global positioning system (GPS), GLONASS (GLO), Galileo (GAL), or BeiDou Navigation Satellite System (BDS); base stations 120; access points (APs) 130; location server 160; network 170; and external client 180. Generally put, the positioning system 100 can estimate the location of the mobile device 105 based on radio frequency (RF) signals received by and/or sent from the mobile device 105 and known locations of other components (e.g., GNSS satellites 110, base stations 120, APs 130) transmitting and/or receiving the RF signals. Additional details regarding GNSS-based positioning are discussed in more detail with regard to FIG. 2.

In this example, FIG. 1 illustrates the mobile device 105 as a smartphone device. However, mobile devices capable of performing the techniques described herein may be any suitable device that includes GNSS capabilities or may be a device or machine into which such GNSS capabilities are integrated. Thus, a mobile device 105 may include personal devices such as a smartphone, smartwatch, tablet, laptop, etc. However, mobile devices may include a larger class of devices as well and may include vehicles with integrated GNSS receivers and positioning systems, such as boats or ships, cars, trucks, aircraft, shipping containers, etc. As noted, in certain contexts, such as in reference to a cellular network, the mobile device 105 may be referred to as a UE.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (cMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with the known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, and/or static communication/positioning device 145-3. When or more other mobile devices 145 are used in the position determination of a particular mobile device 105, the mobile device 105 for which the position is to be determined may be referred to as the “target mobile device,” and each of the one or more other mobile devices 145 used may be referred to as an “anchor mobile device.” For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond with a component or device on a vehicle, RSU, or other V2X entity that is used to communicate V2X messages. The static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, cast or west and possibly above or below some other known fixed location (including, e.g., the location of a base station 120 or AP 130) or some other location such as a location for mobile device 105 at some known previous time, or a location of another mobile device 145 at some known previous time). As noted elsewhere herein, a location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as a friend or relative finder, or child or pet location). Additionally or alternatively, the external client 180 may obtain and provide the location of mobile device 105 to an emergency services provider, government agency, etc.

As noted, the mobile device 105 of FIG. 1 may be capable of GNSS positioning. Details regarding the GNSS positioning of a mobile device 105, or any device comprising a GNSS receiver, are provided hereafter with regard to FIG. 2.

FIG. 2 is a simplified diagram of a GNSS system 200, provided to illustrate how GNSS is generally used to determine an accurate location of a GNSS receiver 208 on earth 201 (also known as “positioning” of the GNSS receiver). Put generally, the GNSS system 200 enables an accurate GNSS position fix of the GNSS receiver 208, which receives RF signals from GNSS satellites 210 (which may correspond with satellites 110 of FIG. 1) from one or more GNSS constellations. The types of GNSS receiver 208 used may vary, depending on the application. In some embodiments, for instance, the GNSS receiver 208 may comprise a standalone device or component incorporated into another device (e.g., mobile device 105 of FIG. 1). This can include, for example, consumer electronics or devices, such as a mobile phone, tablet, laptop, wearable device, vehicle (or in-vehicle device), or the like. In some embodiments, the GNSS receiver 208 may be integrated into industrial or commercial equipment, such as survey equipment, Internet of Things (IoT) devices, etc.

It will be understood that the diagram provided in FIG. 2 is greatly simplified. In practice, there may be dozens of satellites 210 in a given GNSS constellation, and many different types of GNSS systems with corresponding constellations. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, determining the position of a GNSS receiver 208 in three dimensions may rely on determining the distance between the GNSS receiver 208 and four or more satellites 210. As illustrated, 3D coordinates may be based on a coordinate system (e.g., Cartesian coordinates in the format of X, Y, and Z; geographic coordinates in the format of latitude, longitude, and altitude; etc.) centered at the earth's center of mass. A distance between each satellite 210 and the GNSS receiver 208 may be determined using precise measurements made by the GNSS receiver 208 of a difference in time from when an RF signal is transmitted from the respective satellite 210 to when it is received at the GNSS receiver 208. To help ensure accuracy, not only does the GNSS receiver 208 need to accurately determine when the respective signal from each satellite 210 is received, but many additional factors need to be considered and accounted for. These factors include, for example, clock differences at the GNSS receiver 208 and satellite 210 (e.g., clock bias), a precise location of each satellite 210 at the time of transmission (e.g., as determined by the broadcast ephemeris), the impact of atmospheric distortion (e.g., ionospheric and tropospheric delays), and the like.

To perform a traditional GNSS position fix, the GNSS receiver 208 can use code-based positioning to determine its distance to each satellite 210 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 210, the GNSS receiver 208 can then determine a position fix for its location. This position fix may be determined, for example, by a Standalone Positioning Engine (SPE) executed by one or more processors of the GNSS receiver 208. However, code-based positioning is relatively inaccurate and, without error correction, and is subject to many of the previously described errors. Even so, code-based GNSS positioning can provide a positioning accuracy for the GNSS receiver 208 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 210 observed by the GNSS receiver 208 can be mitigated or canceled based on similar carrier-based ranging of the satellites 210 using a highly accurate GNSS receiver at the base station at a known location. These measurements and the base station's location can be provided to the GNSS receiver 208 for error correction. This position fix may be determined, for example, by a Precise Positioning Engine (PPE) executed by one or more processors of the GNSS receiver 208. More specifically, in addition to the information provided to an SPE, the PPE may use base station GNSS measurement information and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 2, the satellites 210 may be members of a single satellite constellation, i.e., a group of satellites that are part of a GNSS system, e.g., controlled by a common entity such as a government, and orbiting in complementary orbits to facilitate determining positions of entities around the world. One or more of the satellites 210 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites; the X-band, used by the military and for RADAR applications; and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

As previously noted, precise positioning (e.g., RTK or PPP positioning) may utilize error correction provided by an error correction service. Error correction is typically provided using SSR or OSR. As previously noted, OSR utilizes a format in which a “lump sum” of error components for carrier phase and pseudorange measurements are provided, typically from a local physical reference station positioning reference signal (PRS). SSR, on the other hand, provides correction of individual error components, such as orbit, clock, SV PCO, and DCB. When SSR transmits enough information, the accuracy of resulting positioning estimates based on SSR can be comparable to the accuracy achieved using OSR. Furthermore, free SSR (with regional or global coverage) is often available for at least some GNSS frequency bands from services such as Quasi-Zenith Satellite System (QZSS) Centimeter Level Augmentation Service (CLAS), QZSS Multi-GNSS Advanced Orbit and Clock Augmentation-Precise Point Positioning (MADOCA-PPP), Galileo (GAL) High Accuracy Service (HAS), and BDS PPP-B2b.

As previously noted, measurement residuals are defined as the difference between measured observations (e.g., PR, CP, and Doppler) and predicted observations once error correction/cancellation has been applied. Moreover, as also noted, residuals may be used to determine measurement quality and position solution accuracy, as well as to train ML models for enhanced GNSS-based positioning. Traditionally, and particularly with GNSS positioning utilizing RTK, existing DD residual computation mostly relies on the accuracy of real-time position estimation (e.g., for in-field, real-time applications using GNSS positioning) or ground-truth (GT) (e.g., when training machine learning models or evaluating the performance of a GNSS product). Residuals can be particularly (and undesirably) large with GNSS devices that, rather than determining positioning solutions every second or epoch, determine positioning solutions based on measurements taken over a relatively longer period of time. As previously noted, these devices may be referred to as devices with “slow positioning cadence” and may include IoT devices and smartphones. Large residuals may also be a result of positioning in a challenging GNSS environment, such as in an urban environment. In applications in which GT is used, for example, such environments can result in no GT or an inaccurate GT.

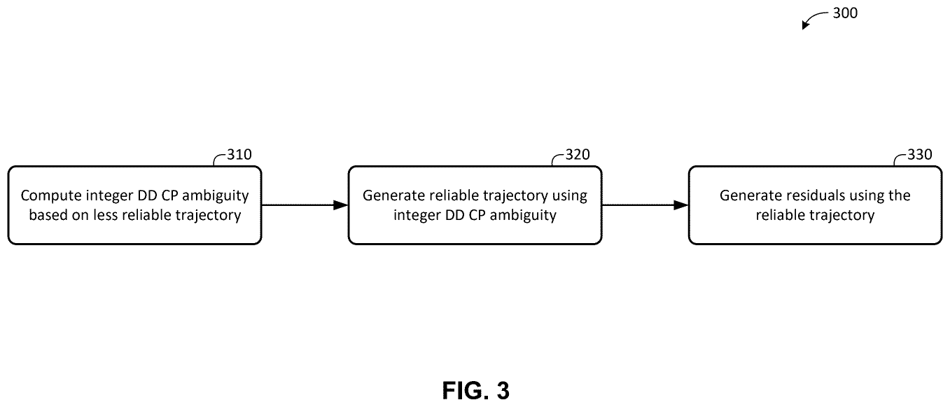

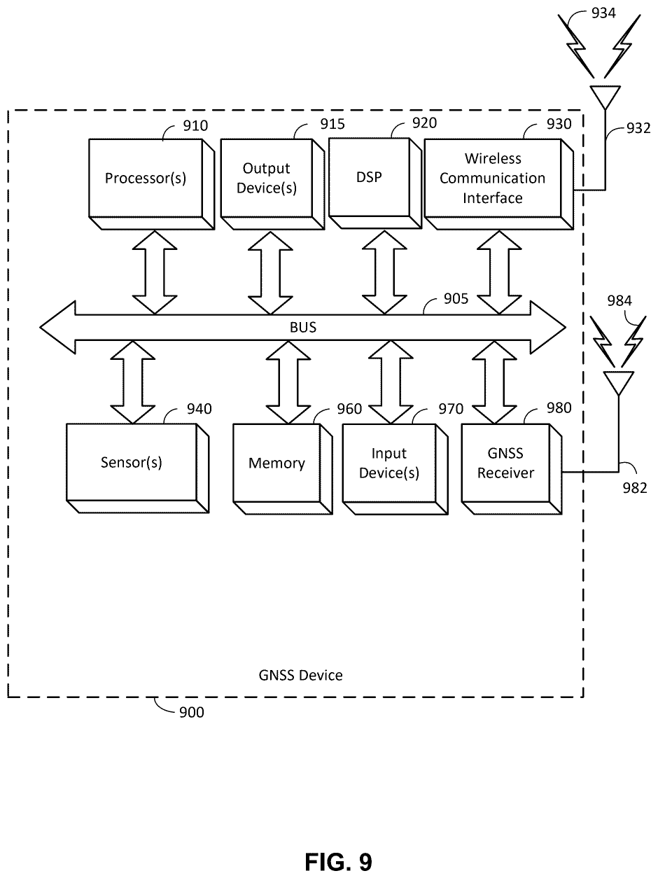

FIG. 3 is a flow diagram of a process 300 utilized by embodiments herein that can be used to improve residual quality. In particular, the process 300 can be used to improve the DD CP residual for precise positioning applications, which can be more impactful than PR or Doppler residuals for precise positioning solutions. The operations illustrated in FIG. 3 may be performed, for example, by software and/or hardware components of a GNSS device (e.g., an RTK rover). Example components of a GNSS device are illustrated in FIG. 9, which is described below.

As illustrated, the process 300 may be performed as follows. It may begin, for example, by computing the integer DD CP ambiguity based on a “less reliable” trajectory, as illustrated with block 310. This less reliable trajectory may be based on an estimated rover position or a provided GT trajectory, for example. The process 300 may then proceed by generating a more reliable trajectory using the DD CP ambiguity, as illustrated with block 320. Residuals may then be generated using this more reliable for the directory, as indicated with block 330. Specific details regarding each of these operations of the process 300 are provided below.

It can be noted that although embodiments described herein primarily focus on GNSS positioning using RTK, embodiments are not so limited. Techniques disclosed herein can apply to non-RTK solutions as well. This can include, for example, differential GNSS (dGNSS) with DD pseudorange only or PPP with precise correction product (without RTK base station). A person of ordinary skill in the art will recognize other such alternative embodiments.

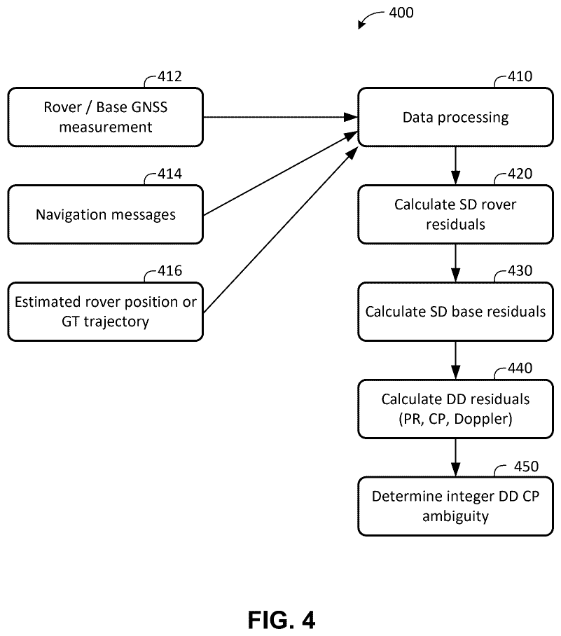

FIG. 4 is a flow diagram of a process 400 by which integer DD CP ambiguity based on a “less reliable” trajectory may be performed, according to some embodiments. This process 400 may correspond to the functionality of block 310 of FIG. 3. As with other figures provided herein, FIG. 4 is provided as a non-limiting example. A person of ordinary skill in the art will appreciate how different modifications may be made (e.g., changing the order of some functions, performing certain functions in parallel, etc.) while ultimately achieving a similar end result that can be used in alternative embodiments.

The process 400 may begin at block 410 with the data processing operation that may use various data inputs. As illustrated, these inputs include rover and base GNSS measurements (or equivalent for non-RTK solutions) shown with block 412, navigation messages (e.g., satellite trajectory) shown with block 414, and an estimated rover position or GT trajectory shown with block 416. The estimated rover position or GT trajectory may be based on availability or use cases: estimated rover position may be used in real-time GNSS receiver products, and GT trajectory can be used in postprocessing software applications, for example. According to some embodiments, the data processing at block 410 may include a rough initial processing of the inputs to help ensure their validity. As such, this may include an initial “sanity check” may be performed to ensure a correct sampling rate, ensure no cycle slip has occurred, or otherwise prevent the process from proceeding if inputs are determined to include bad data.

Single-difference (SD) residuals may then be calculated for rover and base (or equivalent for non-RTK solutions), as indicated with blocks 420 and 430, respectively. According to some embodiments, SD residuals can be calculated using a reference satellite from which measurements from other satellites may be subtracted, which can result in the cancellation/correction of receiver-based components of CP measurements (e.g., receiver clock). As a person of ordinary skill in the art will appreciate, a reference satellite may be chosen based on various factors. For example, according to some embodiments, a satellite with the highest elevation (among detected satellites) may be chosen because the RF signal from that satellite is least likely to experience multipath. As indicated at block 440, the double difference (DD) may then be used to calculate residuals for GNSS measurements (e.g., PR, CP, and Doppler) made by the GNSS device (e.g., rover). (The residuals calculated in block 440 are initial DD residuals that may be improved utilizing the techniques described herein.)

The integer DD of the CP ambiguity may then be determined, as indicated at block 450, using the residuals calculated at block 440. This can be done, for example, using a search method (e.g., Least Squares Ambiguity Decorrelation Adjustment (LAMBDA) for using a simple round-up method. When using the round-up method, some embodiments may employ cycle slip detection to help ensure accurate ambiguity determination.

As noted at block 320 of FIG. 3, once the integer DD CP ambiguity is determined, embodiments may determine a “more reliable” trajectory based on this integer DD CP ambiguity. More specifically, precise CP can be determined, using the integer DD CP ambiguity. A least-squared (e.g., weighted least squares (WLS)) process may then be performed on all CP measurements to generate a modified new position, or “more reliable” trajectory from which more accurate residuals may be determined.

According to some embodiments, the determination of this more reliable trajectory may utilize a DD residual (e.g., determined at block 440 of FIG. 4) as follows:

$${DD}_{CP} residual = D D ( C P ) - DD ( truth range ) = X . Y , \qquad ( Eqn . 1 )$$

where DD(CP) is the determined DD CP, DD(truth range) is the DD CP with applied error correction/cancellation, X is the integer component of ambiguity cycles (solved for using a search method or roundup method, as noted above), and Y is a non-integer part of the CP residual. In most cases (without cycle slip), the absolute value of Y is less than a half cycle. That is, −0.5 cycle<Y<0.5 cycle. (In cases where Y falls outside of this range, it may be treated as an outlier and either repaired or removed from use in the determination of reliable residuals.)

With respect to Eqn. 1 above, a couple of items may be noted. First, DD_{CP}residual=DD(CP)−DD(truth range) is an approximation of the true residual of GNSS DD CP measurement, and may include errors such as DD SV clock, SV orbit, troposphere, ionosphere, noise, multipath, etc. Second, the DD(truth range) term may include errors such as based position offset, rover position offset, phase center variation (PCV) at base, PCV at rover, etc. These can therefore impact the value of Y.

As noted, integer ambiguity (X), which may be found using a search or round-up method. A WLS may then be performed on all CP measurements to generate a modified trajectory position for the GNSS device (e.g., rover). More specifically, the integer ambiguity may be subtracted from the ambiguous CP measurements (CP) to create unambiguous CP measurements (CP−X) that can be used as precise pseudorange to compute WLS solutions. According to some embodiments, a single-shot (rather than recursive) WLS solution may be determined to isolate temporal correlation of error between different epochs.

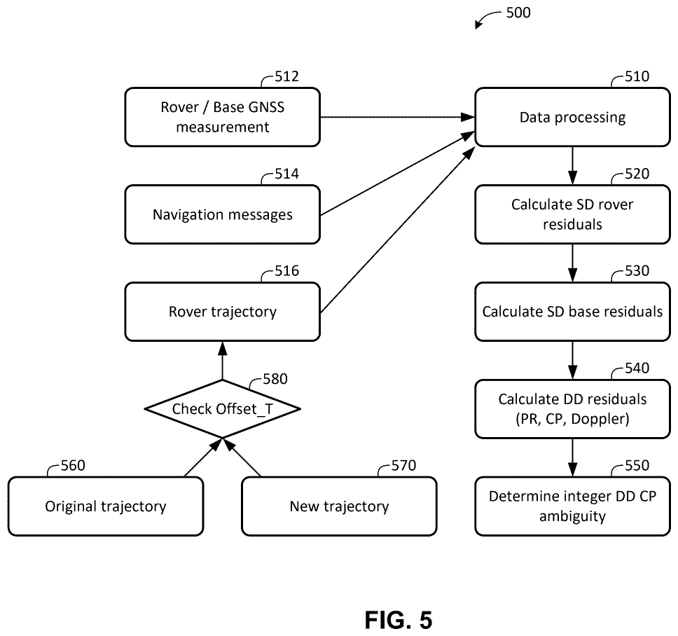

FIG. 5 is a flow diagram of a process 500 by which integer DD CP ambiguity may be based on a “more reliable” trajectory may be performed, according to some embodiments. This process 500 may correspond to the functionality of block 330 of FIG. 3 or “more reliable” trajectory position for the GNSS device as determined in block 320 and described above.

The process 500 may generally reflect the process 400, described above, by which integer DD CP ambiguity may be based on a “less reliable” trajectory. Indeed, the functionality at blocks 510-550 may generally echo the functionality of corresponding blocks 410-450, described above. The process 500, however, has additional functionality shown by blocks 560-580. Specifically, the original old trajectory (block 560) resulting from the process 400 of FIG. 4 may be compared with the reliable/modified trajectory (“new” trajectory of block 570) obtained using the CP-based WLS solution, described above.

At block 580, an offset (Offset_T) is determined between the original trajectory and new trajectory. This can serve as a protection in case the new trajectory is somehow incorrect (which may occur in some cases during cycle slip, for example). This offset can then be compared against a maximum trajectory correction threshold. The threshold may be, for example, one wavelength of a signal (e.g., approximately 20 cm) as a default. However, alternative embodiments may have a threshold of a higher or lower value (e.g., 5 cm, 10 cm, 15 cm, 25 cm, 30 cm, 35 cm, etc.), depending on desired functionality and implementation factors. Depending on how the offset compares with the threshold, the rover trajectory at 516 may comprise either the original trajectory (block 560) or the new trajectory (block 570). For example, according to some embodiments, Offset_T is greater than the threshold, the original trajectory may be used. Otherwise, the new trajectory (again, computed at block 320 of FIG. 3) may be used for generating residuals using the process 500 of FIG. 5.

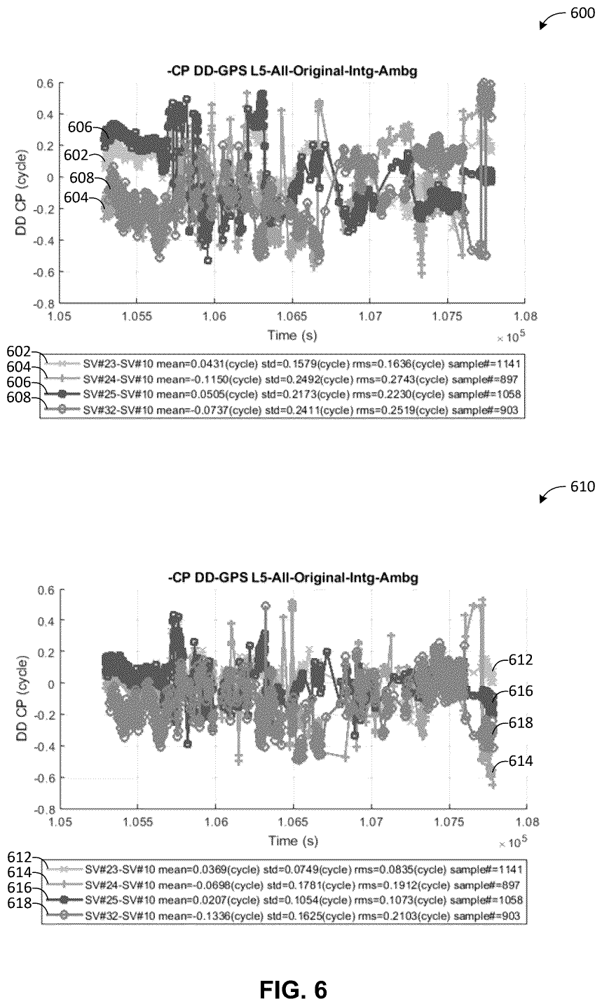

FIG. 6 is an illustration of two graphs showing the improvement of DD CP residuals using the embodiments herein on a sample set of data that uses the GPS L5 band. Both graphs plot DD CP residuals (in cycles) based on measurements of four different satellite signals across a period of time. The first graph 600 plots DD CP residuals determined using traditional techniques (e.g., based on a “less reliable” trajectory), and the second graph 610 plots DD CP residuals determined using the techniques described herein (e.g., based on a “more reliable” trajectory). To help identify and distinguish the plotted data of the four different satellites, labels 602-608 have been used in the first graph 600, and labels 612-618 have been used in the second graph 610. As can be seen, the residuals in graph 610 are generally more accurate (e.g., have smaller mean, standard deviation and root mean square (RMS) values), indicating how embodiments herein represent an improvement of the determination of DD CP residuals over traditional techniques.

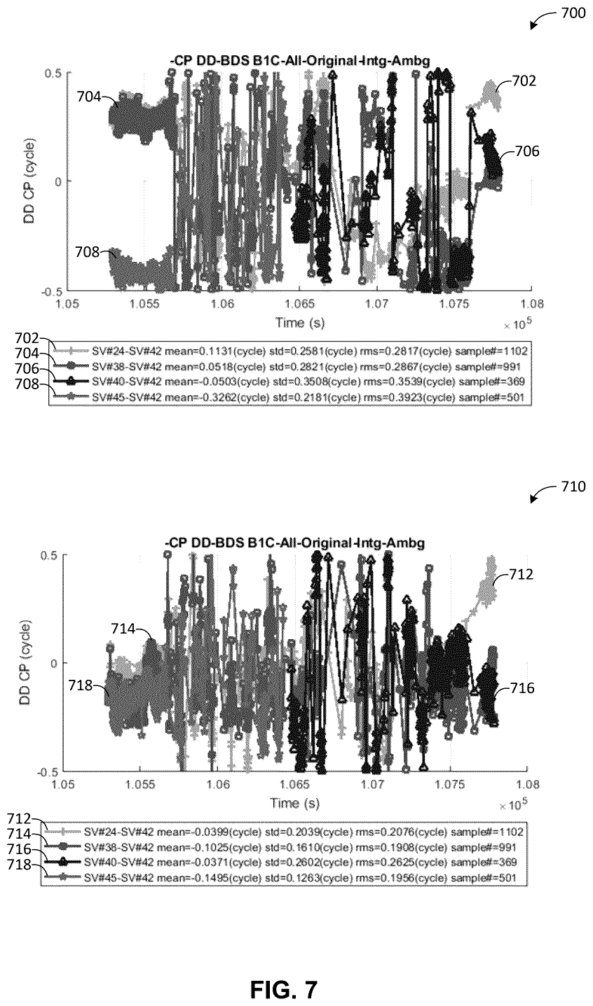

FIG. 7 is another illustration of two graphs showing the improvement of DD CPs residual using the embodiments herein on a sample set of data that uses the BDS BIC band. Both graphs plot DD CP residuals (in cycles) based on measurements of four different satellite signals across a period of time. Again, a first graph 700 plots DD CP residuals determined using traditional techniques (e.g., based on a “less reliable” trajectory), and the second graph 710 plots DD CP residuals determined using the techniques described herein (e.g., based on a “more reliable” trajectory). To help identify and distinguish the plotted data of the four different satellites, labels 702-708 have been used in the first graph 700, and labels 712-718 have been used in the second graph 710. As can be seen, the residuals in graph 710 are generally more accurate (e.g., have smaller mean, standard deviation, and root mean square (RMS) values), indicating how embodiments herein represent an improvement of the determination of DD CP residuals over traditional techniques.

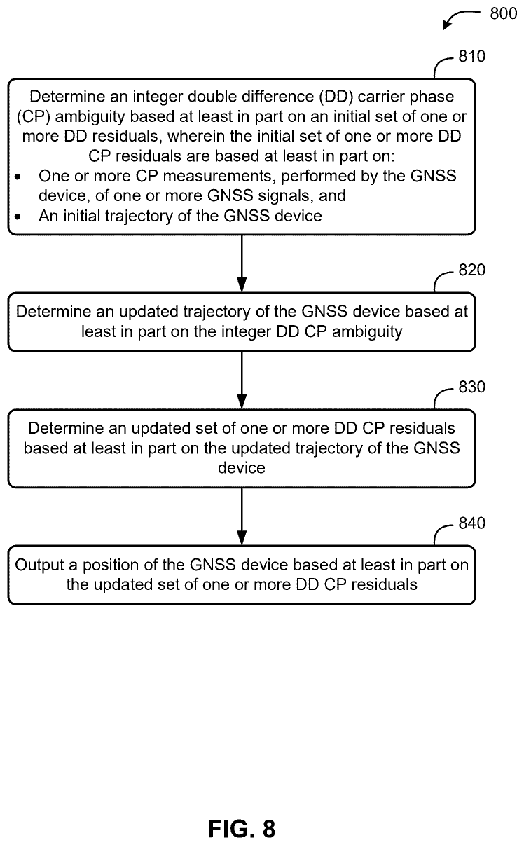

FIG. 8 is a flow diagram of a method 800 of GNSS positioning of a GNSS device, according to an embodiment. The method 800 may be formed by the GNSS device, for example, and aspects of the method 800 are intended to capture various aspects of the functionality described in the embodiments above, including embodiments described with respect to FIGS. 3-6. The functionality of any or all of the blocks of the method 800 may be performed by hardware and/or software components of a GNSS device, an example of which is provided in FIG. 9 and described below. As with other figures, FIG. 8 is provided as a nonlimiting example, and alternative embodiments may include variations from the method 800 (e.g., rearranging functions or performing functions in parallel, etc.) that may result in the same or similar functionality, which a person of ordinary skill in the art will appreciate.

The method 800 may begin with the functionality at block 810, which includes determining an integer double difference (DD) carrier phase (CP) ambiguity based at least in part on an initial set of one or more DD residuals, wherein the initial set of one or more DD CP residuals are based at least in part on: one or more CP measurements, performed by the GNSS device, of one or more GNSS signals, and an initial trajectory of the GNSS device. As described in the embodiments herein (e.g., with respect to FIG. 4), the initial set of one or more DD CP residuals (e.g., block 440 of FIG. 4) may be determined from single difference (SD) residuals determined for a rover and a base (e.g., in the case of RTK positioning (e.g., blocks 420 and 430); or similar in the case of non-RTK positioning). Indeed, according to some embodiments, the GNSS positioning may comprise RTK positioning, and the GNSS device comprises a rover device, and wherein the method further comprises determining the initial set of one or more DD CP residuals based on single difference (SD) residuals of the one or more CP measurements performed by the rover device, and SD residuals of the one or more CP measurements, performed by a base station, of the one or more GNSS signals. According to some embodiments, determining the integer DD CP ambiguity may comprise performing a search method for a round of method, e.g., as described herein.

Means and/or structure of performing functionality at block 810 may comprise hardware and/or software components of a GNSS device. This may include, for example, a bus 905, one or more processors 910, a digital signal processor (DSP) 920, a wireless communication interface 930, one or more sensors 940, at least one memory 960, GNSS receiver 980, and/or other components of a GNSS device 900, as illustrated in FIG. 9.

The functionality at block 820 comprises determining an updated trajectory of the GNSS device based at least in part on the integer DD CP ambiguity. Examples of this are provided in the embodiments herein, including block 570 of FIG. 5 (which may be based on for making the process 400 of FIG. 4, or something similar). According to some embodiments, as described in the embodiments above, determining the updated trajectory of the GNSS device may be based at least in part on the integer DD CP ambiguity comprises performing a weighted least squares (WLS) operation on a difference between each of the one or more CP measurements with the integer DD CP ambiguity.

Means and/or structure of performing functionality at block 820 may comprise hardware and/or software components of a GNSS device. This may include, for example, a bus 905, one or more processors 910, a digital signal processor (DSP) 920, a wireless communication interface 930, one or more sensors 940, at least one memory 960, GNSS receiver 980, and/or other components of a GNSS device 900, as illustrated in FIG. 9.

The functionality at block 830 comprises determining an updated set of one or more DD CP residuals based at least in part on the updated trajectory of the GNSS device. With respect to FIG. 5 described above, for example, this may correspond to the functionality at block 540 in the case where the new trajectory (at block 570) is used. As noted, a check may be performed (e.g., an offset check, such as the one shown at block 580 of FIG. 5), in some embodiments, to ensure the new trajectory is within a threshold distance from the original trajectory. As such, according to some embodiments, determining the updated set of one or more DD CP residuals may be further based on a determination that a difference between the initial trajectory of the GNSS device and the updated trajectory of the GNSS device is less than a threshold value. As noted elsewhere herein, the threshold value may vary, depending on desired functionality. According to some embodiments, for example, the threshold value may comprise a wavelength of the one or more GNSS signals. (This wavelength may comprise a carrier frequency wavelength of the one or more GNSS signals, for example.) Other embodiments may have a different threshold value (e.g., 0.25 wavelength, 0.5 wavelengths, 0.75 wavelengths, 1.25 wavelengths, 125 wavelengths, etc.).

Means and/or structure of performing functionality at block 830 may comprise hardware and/or software components of a GNSS device. This may include, for example, a bus 905, one or more processors 910, a digital signal processor (DSP) 920, a wireless communication interface 930, one or more sensors 940, at least one memory 960, GNSS receiver 980, and/or other components of a GNSS device 900, as illustrated in FIG. 9.

The functionality at block 840 comprises outputting a position of the GNSS device. This functionality may vary depending on the circumstance, desired functionality, and/or other factors. For example, according to some embodiments, this may comprise providing the position of the GNSS device to a component of the GNSS device, providing the position of the GNSS device to an application executed by the GNSS device, sending the position of the GNSS device to another device, displaying the position of the GNSS device on a display of the GNSS device, or any combination thereof.

Means and/or structure of performing functionality at block 840 may comprise hardware and/or software components of a GNSS device. This may include, for example, a bus 905, one or more processors 910, a digital signal processor (DSP) 920, a wireless communication interface 930, one or more sensors 940, at least one memory 960, GNSS receiver 980, and/or other components of a GNSS device 900, as illustrated in FIG. 9.

FIG. 9 is a block diagram of an embodiment of a GNSS device 900, which can be utilized as described herein above (e.g., in association with FIGS. 1-8). In some embodiments, GNSS device 900 may implement a positioning engine (e.g., a PPE) that can perform some or all of the functionality of the method 800 of FIG. 8 and/or operations of FIGS. 3-5. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations (and in which case a GNSS position may be determined for the GNSS receiver 980). Furthermore, the GNSS device 900 may be incorporated into another device, such as a cell phone, vehicle, etc., as previously noted.

The GNSS device 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The GNSS device 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The GNSS device 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 900 to communicate with other devices as described in the embodiments above. The wireless communication interface 930 may permit data and signaling to be communicated (e.g., transmitted and received) with base stations of a network, for example, via eNBs, gNBs, ng-eNBs, access points, and/or other access node types, and/or other network components, computer systems, and/or any other electronic devices communicatively coupled with base stations, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and/or other terrestrial transceivers, such as wireless devices and access points. The GNSS device 900 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 900 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the GNSS device 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 910 or DSP 920.

The GNSS device 900 may further include and/or be in communication with a memory 960. The memory 960 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the GNSS device 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the GNSS device 900 (and/or processor(s) 910 or DSP 920 within GNSS device 900). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1: A method of global navigation satellite system (GNSS) positioning of a GNSS device, the method comprising: determining an integer double difference (DD) carrier phase (CP) ambiguity based at least in part on an initial set of one or more DD residuals, wherein the initial set of one or more DD CP residuals are based at least in part on: one or more CP measurements, performed by the GNSS device, of one or more GNSS signals, and an initial trajectory of the GNSS device; determining an updated trajectory of the GNSS device based at least in part on the integer DD CP ambiguity; determining an updated set of one or more DD CP residuals based at least in part on the updated trajectory of the GNSS device; and outputting a position of the GNSS device based at least in part on the updated set of one or more DD CP residuals.
Clause 2: The method of clause 1, wherein determining the updated set of one or more DD CP residuals is further based on a determination that a difference between the initial trajectory of the GNSS device and the updated trajectory of the GNSS device is less than a threshold value.
Clause 3: The method of clause 2, wherein the threshold value comprises a wavelength of the one or more GNSS signals.
Clause 4: The method of any one of clauses 1-3, wherein determining the integer DD CP ambiguity comprises performing a search method or a round-up method.
Clause 5: The method of any one of clauses 1-4, wherein the GNSS positioning comprises RTK positioning, and the GNSS device comprises a rover device, and wherein the method further comprises determining the initial set of one or more DD CP residuals based on: single difference (SD) residuals of the one or more CP measurements performed by the rover device, and SD residuals of the one or more CP measurements, performed by a base station, of the one or more GNSS signals.
Clause 6: The method of any one of clauses 1-5, wherein determining the updated trajectory of the GNSS device based at least in part on the integer DD CP ambiguity comprises performing a weighted least squares (WLS) operation on a difference between each of the one or more CP measurements with the integer DD CP ambiguity.
Clause 7: The method of any one of clauses 1-6, wherein outputting the position of the GNSS device comprises: providing the position of the GNSS device to a component of the GNSS device, providing the position of the GNSS device to an application executed by the GNSS device, sending the position of the GNSS device to another device, displaying the position of the GNSS device on a display of the GNSS device, or any combination thereof.
Clause 8: A global navigation satellite system (GNSS) device comprising: one or more GNSS receivers; one or more memories; and one or more processors communicatively coupled with the one or more GNSS receivers and one or more memories, the one or more processors configured to: determine an integer double difference (DD) carrier phase (CP) ambiguity based at least in part on an initial set of one or more DD residuals, wherein the initial set of one or more DD CP residuals are based at least in part on: one or more CP measurements, performed by the GNSS device using the one or more GNSS receivers, of one or more GNSS signals, and an initial trajectory of the GNSS device; determine an updated trajectory of the GNSS device based at least in part on the integer DD CP ambiguity; determine an updated set of one or more DD CP residuals based at least in part on the updated trajectory of the GNSS device; and output a position of the GNSS device based at least in part on the updated set of one or more DD CP residuals.
Clause 9: The GNSS device of clause 8, wherein, the one or more processors are configured to determine the updated set of one or more DD CP residuals further based on a determination that a difference between the initial trajectory of the GNSS device and the updated trajectory of the GNSS device is less than a threshold value.
Clause 10: The GNSS device of clause 9, wherein the threshold value comprises a wavelength of the one or more GNSS signals.
Clause 11: The GNSS device of any one of clauses 8-10, wherein, to determine the integer DD CP ambiguity, the one or more processors are configured to perform a search GNSS device or a round-up GNSS device.
Clause 12: The GNSS device of any one of clauses 8-11, wherein the GNSS positioning comprises RTK positioning, and the GNSS device comprises a rover device, and wherein the one or more processors are further configured to determine, the initial set of one or more DD CP residuals based on: single difference (SD) residuals of the one or more CP measurements performed by the rover device, and SD residuals of the one or more CP measurements, performed by a base station, of the one or more GNSS signals.
Clause 13: The GNSS device of any one of clauses 8-12, wherein, to determine the updated trajectory of the GNSS device based at least in part on the integer DD CP ambiguity, the one or more processors are configured to perform a weighted least squares (WLS) operation on a difference between each of the one or more CP measurements with the integer DD CP ambiguity.
Clause 14: The GNSS device of any one of clauses 8-13, wherein, to output the position of the GNSS device, the one or more processors are configured to: provide the position of the GNSS device to a component of the GNSS device, provide the position of the GNSS device to an application executed by the GNSS device, send the position of the GNSS device to another device, display the position of the GNSS device on a display of the GNSS device, or any combination thereof.
Clause 15: An apparatus comprising: means for determining an integer double difference (DD) carrier phase (CP) ambiguity based at least in part on an initial set of one or more DD residuals, wherein the initial set of one or more DD CP residuals are based at least in part on: one or more CP measurements, performed by a global navigation satellite system (GNSS) device, of one or more GNSS signals, and an initial trajectory of the GNSS device; means for determining an updated trajectory of the GNSS device based at least in part on the integer DD CP ambiguity; means for determining an updated set of one or more DD CP residuals based at least in part on the updated trajectory of the GNSS device; and means for outputting a position of the GNSS device based at least in part on the updated set of one or more DD CP residuals.
Clause 16: The apparatus of clause 15, wherein the means for determining the updated set of one or more DD CP residuals is configured to determine the updated set of one or more DD CP residuals further based on a determination that a difference between the initial trajectory of the GNSS device and the updated trajectory of the GNSS device is less than a threshold value.
Clause 17: The apparatus of either of clauses 15 or 16, wherein the means for determining the integer DD CP ambiguity comprises means for performing a search apparatus or a round-up apparatus.
Clause 18: The apparatus of any one of clauses 15-17, wherein the GNSS positioning comprises RTK positioning, and the GNSS device comprises a rover device, and wherein the apparatus further comprises means for determining the initial set of one or more DD CP residuals based on: single difference (SD) residuals of the one or more CP measurements performed by the rover device, and SD residuals of the one or more CP measurements, performed by a base station, of the one or more GNSS signals.
Clause 19: The apparatus of any one of clauses 15-18, wherein means for determining the updated trajectory of the GNSS device based at least in part on the integer DD CP ambiguity comprises means for performing a weighted least squares (WLS) operation on a difference between each of the one or more CP measurements with the integer DD CP ambiguity.
Clause 20: The apparatus of any one of clauses 15-19, wherein the means for outputting the position of the GNSS device comprises: means for providing the position of the GNSS device to a component of the GNSS device, means for providing the position of the GNSS device to an application executed by the GNSS device, means for sending the position of the GNSS device to another device, means for displaying the position of the GNSS device on a display of the GNSS device, or any combination thereof.
Clause 21: An apparatus having means for performing the method of any one of clauses 1-7.
Clause 22: A non-transitory computer-readable medium storing instructions, the instructions comprising code for performing the method of any one of clauses 1-8.

What is claimed is:

1. A method of global navigation satellite system (GNSS) positioning of a GNSS device, the method comprising:
determining an integer double difference (DD) carrier phase (CP) ambiguity based at least in part on an initial set of one or more DD residuals, wherein the initial set of one or more DD CP residuals are based at least in part on:
one or more CP measurements, performed by the GNSS device, of one or more GNSS signals, and
an initial trajectory of the GNSS device;
determining an updated trajectory of the GNSS device based at least in part on the integer DD CP ambiguity;
determining an updated set of one or more DD CP residuals based at least in part on the updated trajectory of the GNSS device; and
outputting a position of the GNSS device based at least in part on the updated set of one or more DD CP residuals.

2. The method of claim 1, wherein determining the updated set of one or more DD CP residuals is further based on a determination that a difference between the initial trajectory of the GNSS device and the updated trajectory of the GNSS device is less than a threshold value.

3. The method of claim 2, wherein the threshold value comprises a wavelength of the one or more GNSS signals.

4. The method of claim 1, wherein determining the integer DD CP ambiguity comprises performing a search method or a round-up method.

5. The method of claim 1, wherein the GNSS positioning comprises RTK positioning, and the GNSS device comprises a rover device, and wherein the method further comprises determining the initial set of one or more DD CP residuals based on:
single difference (SD) residuals of the one or more CP measurements performed by the rover device, and
SD residuals of the one or more CP measurements, performed by a base station, of the one or more GNSS signals.

6. The method of claim 1, wherein determining the updated trajectory of the GNSS device based at least in part on the integer DD CP ambiguity comprises performing a weighted least squares (WLS) operation on a difference between each of the one or more CP measurements with the integer DD CP ambiguity.

7. The method of claim 1, wherein outputting the position of the GNSS device comprises:
providing the position of the GNSS device to a component of the GNSS device,
providing the position of the GNSS device to an application executed by the GNSS device,
sending the position of the GNSS device to another device,
displaying the position of the GNSS device on a display of the GNSS device, or
any combination thereof.

8. A global navigation satellite system (GNSS) device comprising:
one or more GNSS receivers;
one or more memories; and
one or more processors communicatively coupled with the one or more GNSS receivers and one or more memories, the one or more processors configured to:
determine an integer double difference (DD) carrier phase (CP) ambiguity based at least in part on an initial set of one or more DD residuals, wherein the initial set of one or more DD CP residuals are based at least in part on:
one or more CP measurements, performed by the GNSS device using the one or more GNSS receivers, of one or more GNSS signals, and
an initial trajectory of the GNSS device;
determine an updated trajectory of the GNSS device based at least in part on the integer DD CP ambiguity;
determine an updated set of one or more DD CP residuals based at least in part on the updated trajectory of the GNSS device; and
output a position of the GNSS device based at least in part on the updated set of one or more DD CP residuals.

9. The GNSS device of claim 8, wherein, the one or more processors are configured to determine the updated set of one or more DD CP residuals further based on a determination that a difference between the initial trajectory of the GNSS device and the updated trajectory of the GNSS device is less than a threshold value.

10. The GNSS device of claim 9, wherein the threshold value comprises a wavelength of the one or more GNSS signals.

11. The GNSS device of claim 8, wherein, to determine the integer DD CP ambiguity, the one or more processors are configured to perform a search GNSS device or a round-up GNSS device.

12. The GNSS device of claim 8, wherein the GNSS positioning comprises RTK positioning, and the GNSS device comprises a rover device, and wherein the one or more processors are further configured to determine, the initial set of one or more DD CP residuals based on:
single difference (SD) residuals of the one or more CP measurements performed by the rover device, and
SD residuals of the one or more CP measurements, performed by a base station, of the one or more GNSS signals.

13. The GNSS device of claim 8, wherein, to determine the updated trajectory of the GNSS device based at least in part on the integer DD CP ambiguity, the one or more processors are configured to perform a weighted least squares (WLS) operation on a difference between each of the one or more CP measurements with the integer DD CP ambiguity.

14. The GNSS device of claim 8, wherein, to output the position of the GNSS device, the one or more processors are configured to:
provide the position of the GNSS device to a component of the GNSS device,
provide the position of the GNSS device to an application executed by the GNSS device,
send the position of the GNSS device to another device,
display the position of the GNSS device on a display of the GNSS device, or
any combination thereof.

15. An apparatus comprising:
means for determining an integer double difference (DD) carrier phase (CP) ambiguity based at least in part on an initial set of one or more DD residuals, wherein the initial set of one or more DD CP residuals are based at least in part on:
one or more CP measurements, performed by a global navigation satellite system (GNSS) device, of one or more GNSS signals, and
an initial trajectory of the GNSS device;
means for determining an updated trajectory of the GNSS device based at least in part on the integer DD CP ambiguity;
means for determining an updated set of one or more DD CP residuals based at least in part on the updated trajectory of the GNSS device; and
means for outputting a position of the GNSS device based at least in part on the updated set of one or more DD CP residuals.

16. The apparatus of claim 15, wherein the means for determining the updated set of one or more DD CP residuals is configured to determine the updated set of one or more DD CP residuals further based on a determination that a difference between the initial trajectory of the GNSS device and the updated trajectory of the GNSS device is less than a threshold value.

17. The apparatus of claim 15, wherein the means for determining the integer DD CP ambiguity comprises means for performing a search apparatus or a round-up apparatus.

18. The apparatus of claim 15, wherein the GNSS positioning comprises RTK positioning, and the GNSS device comprises a rover device, and wherein the apparatus further comprises means for determining the initial set of one or more DD CP residuals based on:
single difference (SD) residuals of the one or more CP measurements performed by the rover device, and
SD residuals of the one or more CP measurements, performed by a base station, of the one or more GNSS signals.

19. The apparatus of claim 15, wherein means for determining the updated trajectory of the GNSS device based at least in part on the integer DD CP ambiguity comprises means for performing a weighted least squares (WLS) operation on a difference between each of the one or more CP measurements with the integer DD CP ambiguity.

20. The apparatus of claim 15, wherein the means for outputting the position of the GNSS device comprises:
means for providing the position of the GNSS device to a component of the GNSS device,
means for providing the position of the GNSS device to an application executed by the GNSS device,
means for sending the position of the GNSS device to another device,
means for displaying the position of the GNSS device on a display of the GNSS device, or
any combination thereof.
